(19) United States
(12) Patent Application Publication
(10) Pub. No.: US 2022/0011046 A1
(43) Pub. Date: Jan. 13, 2022

(54) COOLING DEVICE

(71) Applicant: Kaelo Technology Ltd., London (GB)

(72) Inventor: Kevin Jabou, London (GB)

(21) Appl. No.: 17/292,428

(22) PCT Filed: Nov. 8, 2019
(86) PCT No.: PCT/GB2019/053172

§ 371 Date: May 7, 2021

(30) Foreign Application Priority Data
Nov. 9, 2018 (GB) 1818321.0

(51) Int. Cl. F25D 31/00; F25D 27/00

(52) U.S. Cl. CPC F25D 31/007; F25D 2327/001; F25D 2331/803; F25D 27/00

(57) ABSTRACT

A bottle cooler may include an annular support structure, a hollow open-topped receptacle, and a bezel. The support structure may have a hanging shoulder protruding radially outwardly. The receptacle may be suspended from the support structure. The bezel may surround the open top of the receptacle and may cover the hanging shoulder.

### TECHNICAL FIELD

The invention relates to a cooling device for maintaining the temperature of drinks bottles at a desired drinking temperature. More specifically, the invention relates to a cooling device capable of keeping beverage bottles cool for extended periods of time in hot environments, for maintaining the temperature of beverage bottles at a specified level and to a device capable of heating beverage bottles.

### BACKGROUND

Luxury spirits and fine wines are best experienced under specific conditions. For example, it is well known that champagne should be drunk at a temperature in the range of 7° C. and 10° C. It is therefore desirable to maintain the contents of a bottle within a desired temperature range. Moreover, the bottle must also be correctly cooled or warmed, as rapid change may damage the contents, rendering them unpleasant to consume or even undrinkable.

Prior to opening, bottle temperatures are easily regulated by storing the bottle in a wine fridge or cellar. However, as the environment in which the beverage is to be drunk is likely to be warmer, removing the bottle from the fridge or cellar immediately begins a warming process. The temperature of the beverage must be regulated correctly during this period between opening and pouring/drinking.

Currently, a flawed (but popular) solution to this problem is to use an ice bucket—a container filled with water and ice into which the bottle is placed. Unfortunately, ice buckets are unsightly, difficult to move, and inconvenient, taking up a large amount of table top space. Also, as temperature regulation is not possible with an ice bucket, the drink temperature may drop well below the optimal temperature before rising again as the ice melts. When the ice has melted, the water will return to room temperature, bringing the temperature of the bottle to room temperature with it. Therefore, there is a very small window in which the bottle's contents are at the correct temperature.

A different, more effective, approach is seen in the Applicant's applications WO 2011/148182 and WO 2017/137774, which describes a powered bottle-cooling device that provides an alternative to an ice bucket. The device is suspended from a supporting lip, and has an open-topped internal chamber that is cooled thermoelectrically. The devices disclosed in WO 2011/148182 and WO 2017/137774 are efficient in operation but suffer from some problems.

FIG. 1 shows the rim 100 of the device disclosed in WO 2017/137774. The rim 100 is manufactured from a solid piece of metal such as aluminium or stainless steel and a screw 102 is used to secure the rim 100 to the frame 101. The rim 100 disclosed in WO 2017/137774 is expensive to manufacture as it must be strong enough to support the entire weight of the cooling device. Furthermore, the rim 100 cannot be removed for maintenance or the like without first removing the entire cooling device from the surface, In particular access to the screw 102 is obstructed when the cooling device is installed on a surface.

WO 2017/137774 further discloses a vessel for receiving and cooling the beverage bottle. The vessel in WO 2017/137774 is manufactured from a solid piece of aluminium that is machined to the desired dimensions. Beneficially, machining the vessel from a solid piece of aluminium gives good thermal conductivity properties; however, manufacturing the vessel in this way is both expensive and wasteful of material. Thus it is desirable to provide an alternative solution that does not compromise the thermal properties of the vessel.

The present invention has been devised to address or overcome at least some of the aforementioned problems associated with the prior art.

### SUMMARY OF THE INVENTION

According to an aspect of the present invention there is provided a bottle cooler comprising an annular support structure that has a hanging shoulder protruding radially outwardly, a hollow open-topped receptacle that is suspended from the support structure, and a bezel that surrounds the open top of the receptacle and covers the hanging shoulder.

Advantageously, the hanging shoulder may engage a supporting surface such that the cooling device is suspended beneath the supporting surface. The bezel surrounds the open top of the receptacle such that the hanging shoulder is hidden from view from the user in normal use. The bezel does not support the weight of the cooling device and as such it may be removed by a user of the cooling device when the cooling device is fitted to the supporting surface. This allows the bezel to be removed for maintenance purposes or to change the bezel for an alternative bezel if the user wants to change the aesthetic appearance of the cooling device.

The skilled reader will appreciate that whilst reference is made to a bottle cooler the bottle cooler may be used to lower, maintain or raise the temperature of a bottled beverage such that the bottled beverage is stored at a desired drinking temperature.

In an embodiment the bezel may be connected to the support structure by an intermediate attachment element. The intermediate attachment element advantageously enables the bezel to be easily removed from, or secured to, the supporting structure.

The attachment element may comprise a clip for securing the bezel to the attachment element. The clip may form a circular array of clipping features displaced angularly on the attachment element. The bezel may comprise a rim and the rim may engage the clip to secure the bezel to the attachment element. Advantageously the rim facilitates easy engagement of the bezel to the attachment element without the requirement for additional tools or fixings. Furthermore, the clip may be disengageable such that the bezel may be easily removed from the attachment element.

In one embodiment the attachment element may comprise locating pins configured to engage a corresponding engagement slot on the bezel to prevent relative movement between the attachment element and the bezel. This is advantageous as the bezel may comprise a graphical element that aligns with a corresponding graphical element located within the receptacle. In this scenario the locating pins prevent relative angular movement of the bezel such that the graphical elements remain aligned.

In another embodiment a radially extending tab may connect the bezel to the annular support structure. The tab, or radially extending arm, may be easily engaged with the annular support structure through rotational movement or indexing. Alternatively, the tab may engage the annular support structure through linear movement.

In one embodiment the attachment element may comprise the tab. The tab may be rotatably engageable with the annular support structure. Advantageously, the bezel may be attached to the attachment element so as to provide an aesthetically pleasing appearance to the cooling device. The bezel and attachment element may be provided as a discrete sub-assembly that is easily engaged with the supporting structure via the tab. In an embodiment the annular support structure may comprise at least one support clip for engaging the tab. The support clip may form a circular array of support clips positioned to engage corresponding tabs on the attachment element.

In an embodiment the bezel may be removable from the annular support structure. The supporting structure bears the weight of the cooling device and as such the bezel may be easily removed from the annular support structure when the cooling device is in position. The bezel may be removed, for example, by applying a force in an upward direction or by rotating the bezel.

In another embodiment an annular gasket may cover a portion of the open top of the receptacle such that when a bottle is located in the receptacle the gasket forms a seal between the bottle and the receptacle. Advantageously, the gasket may help insulate the receptacle to prevent cold air from escaping from the receptacle. Furthermore, the gasket may prevent sunlight being incident on the lower portion of the bottle where the beverage is stored.

In an embodiment the at least one support clip may comprise an upper engagement lip and a lower engagement lip and the support clip may be configured such that the tab engages the upper engagement lip when the gasket is present and such that the tab may engage the lower engagement lip when the gasket is not present. Advantageously, the same attachment element may be used with cooling devices where the gasket is fitted and when the gasket is not fitted. When the gasket is positioned between the supporting structure and the attachment element the supporting lip is configured to engage the upper lip.

Optionally, a light source may be mounted on the annular support structure. Advantageously the light source may illuminate a region at the top of the receptacle such that the cooling device is more aesthetically appealing to a user. Furthermore, the light source may be used to communicate a selected operating mode to a user of the cooling device. For example, the operating mode may correspond to a temperature that the bottled beverage is to be maintained at.

In an embodiment the support structure may comprise a lip positioned between the light source and the receptacle configured to provide a thermal barrier between the light source and the receptacle. Advantageously, the lip prevents heat from the light source from reaching the receptacle which may cause the temperature of the receptacle to increase.

According to another aspect of the present invention there is provided a bottle cooler, comprising: a hollow open-topped receptacle, a bezel that surrounds the open top of the receptacle, and a light source. The bezel is attached to the bottle cooler by an attachment element that is configured to convey light emitted by the light source to the open top of the receptacle.

In an embodiment the attachment element may be a diffuser lens.

Advantageously, the attachment element conveys light emitted from the light source to the open top of the receptacle which negates the requirement for an additional lens component. As such this reduces the cost and complexity of the cooling device.

In an embodiment the attachment element may comprise a groove aligned with the light source and the groove may be configured to refract the light towards the open top of the receptacle. Advantageously, the groove improves the scatter and refraction of incident light which in turns provides a more uniform light distribution at the open top of the receptacle.

In another embodiment the groove comprises a light receiving surface and the light receiving surface may have a rough surface finish configured to diffuse incident light emitted from the light source. The top and bottom surface of the attachment element may also have a rough surface finish to promote total internal reflection of the light within the attachment element. In an alternative embodiment all the external surfaces of the attachment element may have a rough surface finish.

In one embodiment the attachment element may comprise a central aperture that extends around the open top of the receptacle. The central aperture may comprise a light emitting surface configured to emit light to the open top of the receptacle.

In another embodiment the receptacle may comprise a tubular wall component comprising an inwardly protruding support flange and a base component. The base component may engage the supporting flange to define a base of the receptacle.

Advantageously, the two part construction of the receptacle reduces the cost and complexity of manufacturing the receptacle compared to manufacturing the receptacle from a single piece of material. Furthermore, the two part construction provides a good thermal connection between the wall component and the base component. This is advantageous as it promotes the rapid transfer of thermal energy through the receptacle.

In an embodiment the base may comprise a step portion and the flange may define an aperture for locating the step portion. The step portion advantageously provides a gap between the cold base and the hot side of the thermoelectric device. This reduces the possibility of thermal energy leaking from the hot side of the peltier device to the cold base component.

In another embodiment the base component may comprise a step portion and the flange may define an aperture for locating the step portion. This advantageously makes assembly of the receptacle easier as the flange may aid location of the base component within the tubular wall component.

In one embodiment the base component may be secured to the wall component by an indent feature on the wall component. In an embodiment the base may comprise a filleted edge and the filleted edge may be configured to engage the indent feature. The indent feature may be created by a punch or a crimping tool that creates an indent on the wall component. In another embodiment the base component may comprise an annular groove and the indent feature may be configured to engage the annular groove.

In an embodiment the indent feature may define an annular ridge on the internal surface of the tubular wall component to secure the base component relative to the wall component.

In another embodiment the wall component may comprise an outwardly protruding flange at an end opposed to the base component. The outwardly protruding flange may be configured to engage and rest on a feature on the annular supporting structure such that the receptacle may be suspended from the supporting structure.

### BRIEF DESCRIPTION OF THE DRAWINGS

Embodiments of the invention will now be described, by way of example only, with reference to the accompanying drawings, in which:

FIG. 1 is a cross-sectional side view of the rim of a cooling device of the prior art;

FIG. 2 is a cross-sectional side view of a cooling device suitable for use with embodiments of the invention;

FIG. 3 is an enlarged cross-sectional side view of a hanging assembly and bezel of the cooling device of FIG. 2;

FIG. 4 is a perspective view of an attachment element suitable for use with embodiments of the invention;

FIG. 5 is an enlarged cross sectional side view of a bezel and an attachment element suitable for use with embodiments of the invention;

FIG. 6 is a perspective view of an annular support structure suitable for use with embodiments of the invention;

FIG. 7 is a schematic cross-sectional view of the attachment element in a disengaged position relative to the annular supporting structure;

FIG. 8 is a schematic cross-sectional view of the attachment element in an engaged position relative to the annular supporting structure;

FIG. 9 is an enlarged cross-sectional detail side view showing a locating feature on the annular support structure of FIG. 6;

FIG. 10 is an enlarged cross-sectional detail side view of the locating feature of FIG. 8 fitted with a bottle seal;

FIG. 11 is a cross-sectional side view of a receptacle and cooling module suitable for use with embodiments of the invention;

FIG. 12 is a cross-sectional side view of the receptacle of FIG. 11;

FIG. 13 is a cross-sectional side view of the base of a receptacle suitable for use with alternative embodiments of the invention;

FIG. 14 is a cross-sectional side view of he base of a receptacle suitable for use with a further embodiment of the invention;

FIG. 15 is a perspective view of the base of the receptacle suitable for use with embodiments of the invention;

FIG. 16 is a cross sectional view of a tooling arrangement suitable for manufacturing the cooling device using friction welding;

FIG. 17 is a perspective view of the annular support structure of FIG. 6 connected to a chassis;

FIG. 18 is an exploded perspective view of the annular support structure of FIG. 6 and an outer casing arrangement;

FIG. 19 is a cross sectional view of a cooling fan connected to the cooling module; and

FIG. 20 is an enlarged detail perspective view of a cable and a cable clamp suitable for use with embodiments of the invention.

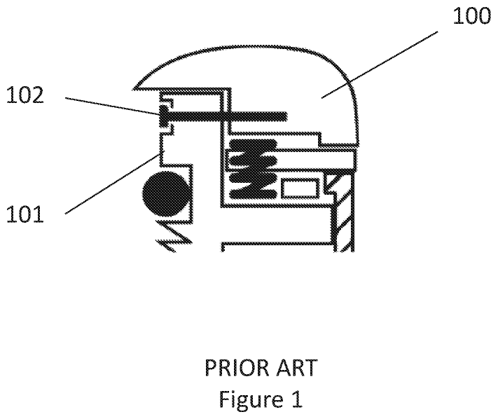

### DETAILED DESCRIPTION

In general terms embodiments of the invention relate to a cooling device for regulating the temperature of beverage bottles. The cooling device is designed to be integrated seamlessly into items of furniture or the like. The cooling device has a receptacle that defines a chamber for receiving a beverage bottle. The temperature of the chamber is regulated by a temperature regulating means, such as a thermoelectric cooling device such that the temperature of the beverage bottle may be maintained at a desired drinking temperature.

An annular support structure is connected to the receptacle such that the receptacle hangs beneath the annular supporting structure. The annular support structure has a hanging shoulder protruding radially outwardly which is configured to engage a supporting surface, such as a table top, work surface, vehicle interior, yacht fitting or any other planar surface on a piece of furniture, such that the receptacle is supported beneath the supporting surface.

The cooling device further comprises a bezel positioned, when assembled, such that it covers the annular support structure and hanging shoulder. The bezel provides an aesthetically appealing finish to the cooling device such that it may be elegantly integrated with, an item of furniture, a vehicle interior, a yacht fitting or any similar planar surface. Furthermore, the bezel may be easily removed by the user such that it may be changed for a bezel with a different appearance or it may be removed for maintenance without removing the remainder of the device.

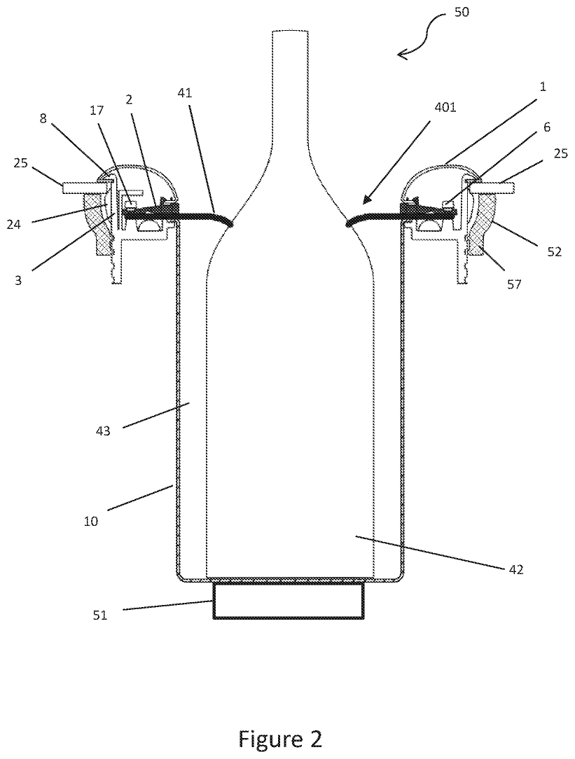

To place embodiments of the invention in a suitable context, reference will now be made to FIG. 2 which shows a cross-sectional view of the cooling device 50 suspended from a supporting surface 25. The cooling device 50 is cylindrical in shape and has a receptacle 10 that defines a chamber for receiving at least a major portion of a beverage bottle 42. The receptacle 10 is suspended from the annular supporting structure 3 by a lip such that it is located beneath the supporting surface 25.

A cooling module 51 configured to regulate the temperature within the receptacle 10 is secured to the base of the receptacle 10 in thermal contact with the receptacle 10. The cooling module 51 includes a thermoelectric cooling device, such as a peltier device, and removes heat from the receptacle 10. Cooling the receptacle creates a sleeve of cold air 43 around the beverage bottle 42 which maintains the temperature of the beverage bottle 42 at the desired drinking temperature. The cooling module 51 is controlled by a control module (not shown).

The supporting structure 3 is an annular support structure configured to suspend the receptacle 10 beneath the supporting surface 25. The supporting structure 3 comprises a hanging shoulder 8 extending radially outwardly from the annular supporting structure 3. The hanging shoulder 8 may be an annular lip that protrudes radially outwardly and is configured to engage the supporting surface 25. In the embodiment shown, the hanging shoulder 8 extends radially outwardly along the entire circumference of the annular supporting structure 3. However, in another embodiment the hanging shoulder 8 may be defined by a plurality of tabs positioned around the circumference of the annular supporting structure 3. The hanging shoulder 8 carries substantially all of the weight of the cooling device 50 and supports the cooling device 50 on the supporting surface 25.

The hanging shoulder 8 enables the cooling device 50 to be fitted in an aperture on a supporting surface 25. A major portion of the cooling device 50 is located beneath the supporting surface 25, in use, such that only the bezel 1 is above the supporting surface 25. The hanging shoulder 8 allows the cooling device 50 to be seamlessly integrated into any planar supporting surface 25. Advantageously, the bezel 1 is not weight bearing thus allowing the bezel 1 to be manufactured from inexpensive sheet material. Furthermore, the bezel 1 may be easily fitted or removed by the user by means of a clipping mechanism.

This allows the user to change the bezel 1 easily or to remove the bezel 1 for maintenance.

The bezel 1 is connected to the supporting structure 3 such that the bezel 1 covers the supporting structure 3 and hanging shoulder 8 to provide an aesthetically pleasing finish for users of the cooling device 50. The bezel 1 provides a seamless or smooth finish between the supporting structure 25 and the interior of the vessel 10.

The bezel 1 is a ring having a central aperture 401 that is largely the same diameter as the internal diameter of the receptacle 10. As such, when the bezel 1 is secured to the support structure 3, access to the chamber of the receptacle 10 is not restricted. The bezel 1 covers the support structure 3 and hanging shoulder 8 when it is fitted to the cooling device 50 but it does not bear the weight of the cooling device 50. In the example shown, the bezel 1 is manufactured from a thin sheet of material, such as sheet metal, and is easily attached to the support structure 3 by a user of the cooling device 50. The bezel 1 may be manufactured from metal spinning, casting or any other suitable manufacturing process.

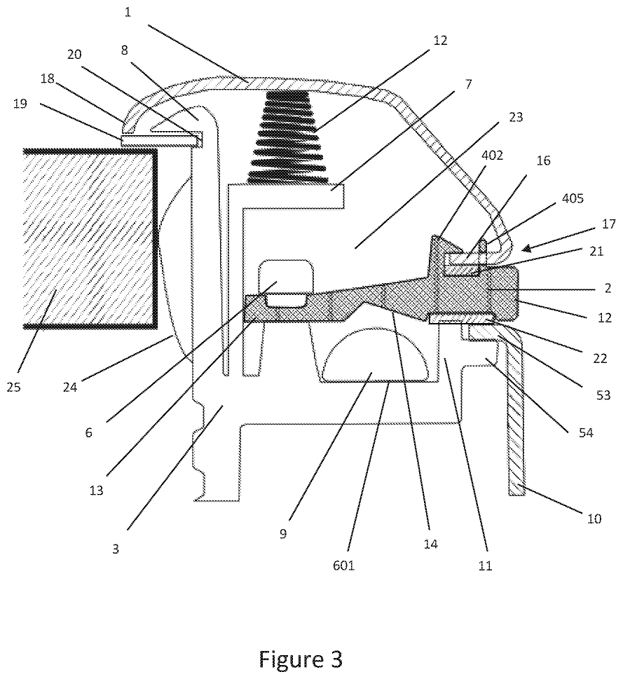

FIG. 3 shows an enlarged cross-sectional view of the top of the receptacle 10 and the hanging shoulder 8. The hanging shoulder 8 is an outwardly protruding lip that is configured to engage and rest upon the supporting surface 25. The supporting structure 3 is an annular structure having a central aperture to accommodate the receptacle 10 and a beverage bottle 42. A protruding flange 53 extends radially outwardly from the top of the receptacle 10. The protruding flange 53 is configured to engage and rest on a corresponding lip 54 that extends radially inwardly towards the central aperture of the supporting structure 3 such that the receptacle 10 is suspended beneath the supporting structure 3 by the lip 54.

The receptacle 10 is secured in position by the attachment element 2 when the bezel 1 and the attachment element 2 are attached to the supporting structure 3. The attachment element 2 prevents upward movement of the receptacle 10 thereby securing the receptacle 10 in position.

As shown in FIG. 3, the bezel 1 has an integral rim 16 on a lower and radially outer side. The rim 16 extends in a radially outward direction away from the central aperture 401 of the bezel 1 such that the rim 16 is hidden from the view of a user of the cooling device 50 when assembled. The rim 16 serves to strengthen the bezel 1 and provides an attachment surface that may be used to secure the bezel 1 to the annular support structure 3.

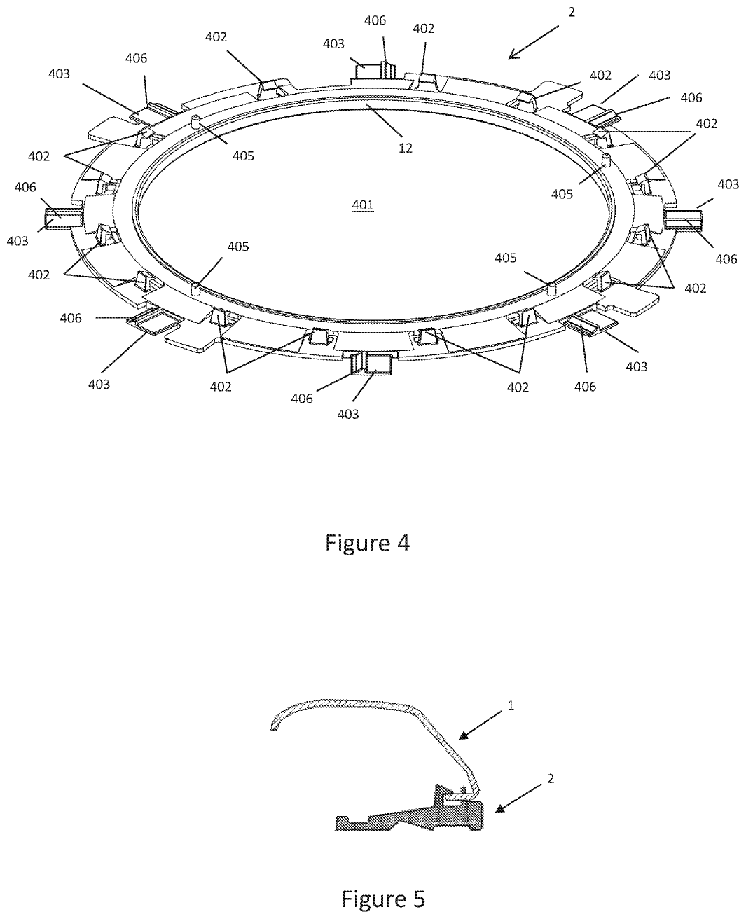

The bezel 1 is attached to the annular supporting structure 3 by the attachment element 2. The attachment element 2, as best viewed in FIG. 4, is a ring with a central aperture 401 that is substantially the same diameter as the diameter of the receptacle 10. In use, an attachment element 2 is located between the top of the receptacle 10 and the bezel 1 such that only an internal face 12 of the attachment element 2 is visible on a radially inner side between the bezel 1 and the receptacle 10. The internal face 12 of the attachment element 2 forms a visible continuous ring around the top of the receptacle 10.

The attachment element 2 has a plurality of snap-fit formations 402 configured to engage the rim 16 of the bezel 1 to secure the bezel 1 to the attachment element 2. The snap-fit formations 402 are distributed angularly in a circular array on the top surface of the attachment element 2. The array of snap-fit formations 402 is arranged concentrically to the central aperture 401. The skilled person will appreciate that any number of snap-fit formations 402 may be used to secure the bezel 1 to the attachment element 2.

As shown in FIG. 4, the snap-fit formations 402 are clips configured to engage the rim 16 of the bezel 1. The snap-fit formations 402 are moveable resiliently in a radially outwardly direction when the rim 16 of the bezel 1 engages a top ramp surface of the snap-fit formations 402. The ramp surface of each snap-fit formation 402 is angled such that when the rim 16 engages the top surface, the snap-fit formation 402 deflects elastically. This elastic deflection allows the snap-fit formations 402 to engage the rim 16 thereby securing the bezel 1 to the attachment element 2. The resilience of the snap-fit formations 402 allow them to snap back to their original positions to secure the bezel 1 to the attachment element 2. The snap-fit formations 402 may be designed to create an irreversible connection between the bezel 1 and the attachment element 2. In an alternative embodiment the snap-fit formations 402 may form a disengageable connection such that the bezel 1 can be removed from the attachment element 2 when the user applies a sufficient force to the bezel 1 in an upward direction.

The attachment element 2 also has a plurality of integral upstanding locating pins 405. The locating pins 405 fit into corresponding locating slots (not shown) positioned on the rim 16 of the bezel 1. The locating pins 405 are positioned such that they will only engage the corresponding locating slots on the rim 16 when the bezel 1 is in a specific angular orientation about the central longitudinal axis of the receptacle 10. Beneficially, the locating pins 405 allow a manufacturing jig to be made that simulates the attachment element 2 such that a logo may be marked on the bezel 1 in a position that corresponds with a logo located on another part of the cooling device 50 such as within the receptacle 10. The locating pins 405 also prevent unwanted rotational movement of the bezel 1 relative to the attachment element 2.

The snap-fit formations 402 allow the bezel 1 to be securely and quickly engaged to the attachment element 2 without the requirement for additional fixing components. This ensures that a completely seamless finish is achieved on the exterior interface 17 between the bezel 1 and the attachment element 2. The bezel 1 and attachment element 2 may be supplied as a discrete sub-assembly, as shown in FIG. 5 that can easily be attached to and/or removed from a cooling device 50. This allows a user of the cooling device 50 to change the bezel 1 that is fitted to the cooling device 50 to vary the aesthetic appearance of the cooling device 50.

The attachment element 2 is secured to the annular supporting structure 3 through a rotational movement. Rotating the attachment element 2 relative to the annular supporting structure 3 causes the locating features on the attachment element 2 to engage corresponding locating features on the annular supporting structure 3. The attachment element 2 may be fitted to the supporting structure 3 prior to fitting the bezel 1 to the attachment element 2.

Alternatively, the bezel 1 and attachment element 2 may be supplied as a discrete sub-assembly as shown in FIG. 5.

The attachment element 2 comprises a plurality of locating features, or radially extending tabs 403, extending radially outwardly from the radial edge of the attachment element 2. The tabs 403 each have a lip 406 that, when the attachment element 2 is rotated relative to the annular supporting structure 3, engage a corresponding locating feature on the supporting structure 3. In the embodiment shown, the locating features on the supporting structure 3 are snap-fit clips 6 arranged to engage the tabs 403 of the attachment element 2.

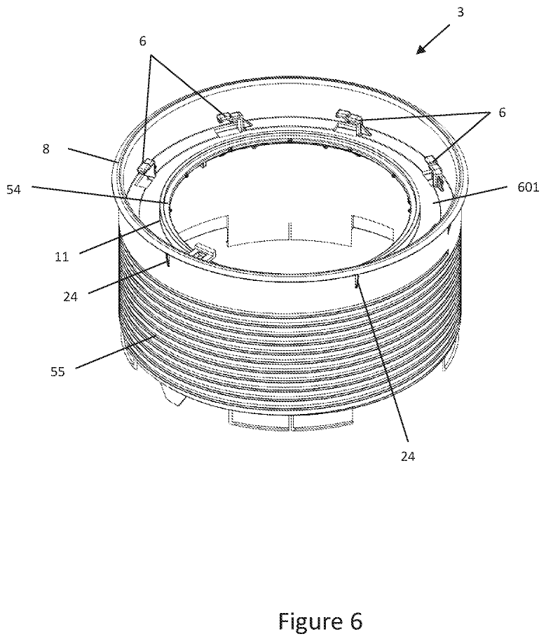

As shown in FIG. 6, the locating features, or snap-fit clips 6, are angularly distributed in a circular array on the annular supporting structure 3. The position of the snap-fit clips 6 correspond with the positions of the radial tabs 403 on the attachment element 2. This enables the radial tabs 403 to engage the snap-fit clips 6 when the attachment element 2 is turned or indexed angularly relative to the annular supporting structure 3 to secure the attachment element 2, and thus the bezel 1, to the annular supporting structure 3. The radial tabs 403 are engaged in the snap-fit clips 6 by first positioning the attachment element 2 within the annular supporting structure 3 and then rotating the attachment element 2 relative to the annular supporting structure 3.

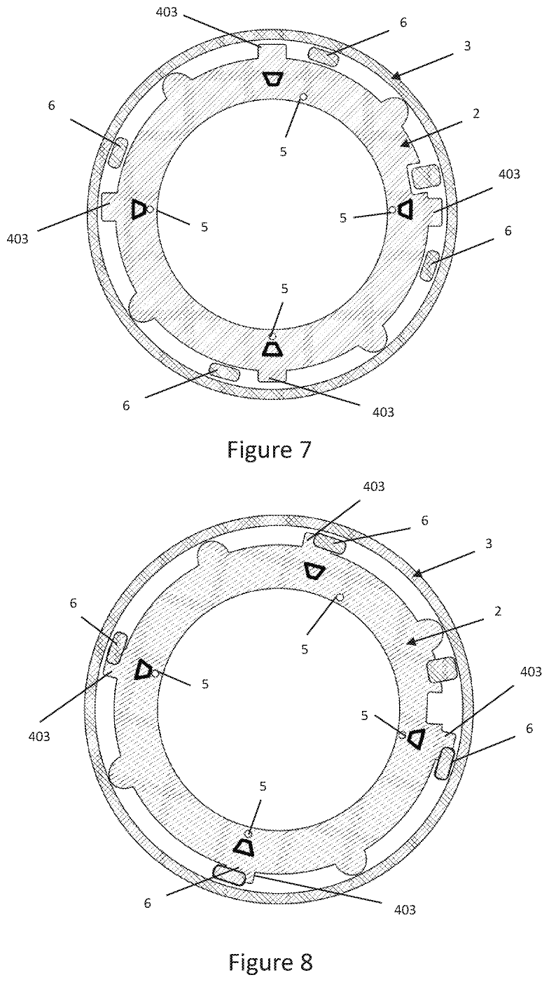

FIG. 7 and FIG. 8 show schematically the attachment element 2 in a disengaged and engaged position respectively. As shown in FIG. 7, when the attachment element 2 is initially positioned within the supporting structure 3 it is orientated in the disengaged position. When in the disengaged position the radial tabs 403 are disengaged from the snap-fit clips 6. Rotating or indexing the attachment element 2 relative to the supporting structure 3 brings the radial tabs 403 into engagement with the annular supporting structure 3 such that the attachment element 2 is in an engaged position, as shown in FIG. 8. Beneficially, the locating pins 405 prevent relative angular movement between the bezel 1 and the attachment element 2 such that when the bezel 1 is secured to the attachment element 2 rotating the bezel 1 causes the radial tabs 403 to engage the clips 6.

The snap-fit clips 6 may be designed to create an irreversible connection between the attachment element 2 and the annular supporting structure 3 or they may be designed such that rotating the bezel 1, and thus attachment element 2, in an opposite angular direction disengages the snap-fit clips 6.

The snap-fit clips 6 are distributed angularly in a circular array. As best shown in FIG. 6, each snap-fit clip 6 is orientated in the same radial direction. This ensures that the tabs 403 are engaged by the snap-fit clips 6 when the attachment element 2 is rotated into an engaged position.

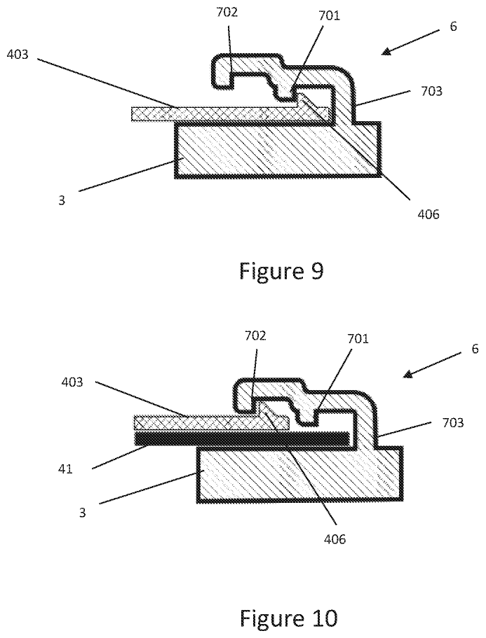

Turning to FIG. 9, the snap-fit clip 6 comprises a root portion 703 that connects the clip 6 to the attachment element 3. The snap-fit clip 6 comprises a lower and upper engagement lip 701, 702. The lower and upper engagement lips 701, 702 are configured to engage the corresponding tab 403 when the attachment element 2 is in the engaged position. The lower and upper engagement lip 701, 702 are offset axially such that the lower engagement lip 701 is located closer to the root portion 703 of the snap-fit clip 6. Furthermore, the lower and upper engagement 701, 702 are positioned at differing vertical distances from the base of the root portion 703. As shown in FIG. 9 the lower engagement lip 701 is located at a lower vertical position relative to the base of the root portion 703 than the upper engagement lip 702.

To mitigate the effect of the cold air 43 escaping from the receptacle 10 a bottle seal 41 may be positioned at the top of the receptacle 10 as shown in FIG. 2. The bottle seal 41 is an annular seal with a central aperture for receiving the beverage bottle 42. The bottle seal 41 is positioned beneath the attachment element 2, in use, and the central aperture forms a seal with the bottle 42. The bottle seal 41 improves the cooling performance of the cooling device 50 by preventing cold air 43 from escaping from the receptacle 10 and also by preventing sunlight being directly incident on the lower part of the beverage bottle 42 that holds the beverage or on the walls of the receptacle 10.

The attachment element 2 and annular support structure 3 of the cooling device 50 are designed such that they may be used in cooling devices 50 both with and without the bottle seal 41. To accommodate both variations of design the locating features, snap-fit clips 6, on the annular support structure 3 may have a double snap-fit arm 6.

FIGS. 9 and 10 show a tab 403 of the attachment element 2 engaged by a snap-fit clip 6 of the annular supporting structure 3. The snap-fit clips 6 have two engagement lips 701, 702 that are positioned at differing spacing relative to the base of the root 703. As shown in FIG. 9, the lip 406 of the tab 403 engages the lower lip 701 of the snap-fit clip 6 when no bottle seal 41 is present. The tab 403 of the attachment element 2 rests on the supporting structure 3 directly and, when the attachment element 2 is rotated relative to the annular supporting structure 3, the tab 403 engages the lower lip 701 of the snap-fit clip 6.

FIG. 10 shows an embodiment where the bottle seal 41 is present. The bottle seal is in the region of 1 mm to 5 mm in thickness which vertically displaces the tab 403. The vertical displacement of the tab 403 by the presence of the bottle seal 41 causes the lip 406 to engage the upper lip 702 when the attachment element 2 is rotated into engagement with the annular supporting structure 3. As the upper lip 702 is further away from the root 703 of the snap-fit clip 6 it is more compliant in the vertical direction than the lower lip 701. This is advantageous as the compliance in the vertical direction of the upper lip 702 accommodates tolerance in the thickness of the bottle seal 41. Furthermore, the bottle seal 41 may be made of an elastomeric material which increases the friction between the attachment element 2 and the support structure 3. Advantageously, the compliant snap-fit clips 6 make it easier to rotate the attachment element 2 into engagement with the annular support structure 3 when the bottle seal 41 is present.

The cooling device 50 has a light source that is configured to provide a continuous ring or ‘halo’ of light at the opening of the receptacle 10 in the vicinity of the external interface 17. A light source, such as a circular array of LEDs 9 as shown in FIG. 3, is positioned within a channel 601 on the annular support structure 3. The circular array of LEDs 9 emit light that is incident on the attachment element 2 located above the array of LEDs 9, in use. Positioning the circular array of LEDs 9 within the channel 601 beneficially helps to thermally insulate the LEDs 9 from the cold receptacle 10. Thermally insulating the LEDs 9 from the receptacle 10 both helps to maintain the receptacle 10 at a cool temperature and prevents condensation forming in the channel 601 which may damage the LEDs 9.

The attachment element 2 is typically made of a translucent polymer or a glass material such that it acts as a diffusion lens capable of conveying the incident light of the LEDs 9 to the opening of the receptacle 10. The continuous ring of light at the opening of the receptacle 10 is created by diffusing light from the LEDs 9 through the attachment element 2, for example by total internal reflection, such that the light is emitted from the internal face 12. This causes the inner face 12 to glow and emit light such that it forms a continuous halo of light around the opening to the receptacle 10. Diffusing the incident light through the attachment element 2 converts the circular pattern of discrete light sources emitted from the array of LEDs 9 into a continuous halo of light emitted from the internal surface 12. This gives the impression to the user of a continuous halo of light around the opening of the receptacle 10.

An annular groove 14 extends around the lower surface of the attachment element 2. The groove 14 enhances the performance of the attachment element 2 as a diffusion lens. The groove 14 is positioned directly above the circular array of LEDs 9 when the cooling device 50 is assembled. The groove 14 is facetted to scatter and refract incident light towards the internal face 12 of the attachment element. Advantageously, the annular notch 14 encourages a brighter and more even glow from the internal face 12 of the attachment element 2 by improving the performance of the attachment element 2 as a diffusion lens.

A frusto-conical profile is preferred on the faces of the annular groove 14, opposed to a notch with a curved cross sectional profile. A frusto-conical profile helps to minimise any diffraction of the incident light into different colours when refracting from white LEDs or other white light emitting sources. The annular groove 14 may be manufactured with a rough surface texture to improve diffusion of the light into the attachment element 2.

The entire outer surface of the attachment element 2 may have a rough surface finish to promote total internal reflection of the light and to reduce the amount of light escaping from the upper and lower faces of the attachment element 2. In another embodiment, the internal face 12 may have a smooth finish to increase the amount of light emitted from the internal face 12. Total internal reflection of the light helps to promote a more even and brighter glow from the internal face 12 thereby giving the user the impression of a halo of light encircling the top of the receptacle 10. It is desirable that the inner surface 12 has a comparatively smooth surface finish to encourage light to be emitted from the inner surface 12. Furthermore a smooth inner surface 12 is desirable as the inner surface 12 is visible to a user of the cooling device 50 and the inner surface 12 is also available for a user to touch.

The attachment element 2 is typically moulded from a rigid polymer with translucent properties. For example, opal polycarbonate may be used to manufacture the attachment element 2 so that the attachment element 2 has sufficient strength to secure the bezel 1 to the annular supporting structure 3 whilst also acting as a diffusion lens.

Furthermore, the opacity of opal polycarbonate may be manipulated through temperature calibration during the manufacturing process or by altering the composition and/or mix of the raw material. This enables the transmission and diffusion properties of the attachment element 2 to be varied and made bespoke to each cooling device 50. For example, it may be desirable to create an attachment element 2 that is more opaque, thereby creating a dimmer glow from the internal face 12 for cooling devices located within dimly lit environments such as night clubs. Conversely, it may be desirable to create an attachment element 2 that is less opaque for use in cooling devices 50 that are used in brighter environments such as on a yacht or an outdoor space.

The attachment element 2 is sandwiched between the top of the receptacle 10 and the bezel 1 such that only the inner face 12 of the attachment element 2 is visible between the bezel 1 and the receptacle 10. A top annular groove 21 located on a top face of the attachment element 2 proximal to the inner face 12.

Similarly, a bottom annular groove 22 is positioned on the bottom face of the attachment element 2, opposed to the top annular groove 21. The top and bottom annular grooves 21, 22 are configured to receive gaskets to create a watertight seal between the attachment element 2 and bezel 1 and between the attachment element 2 and the receptacle 10 respectively. The bottom and/or top gaskets may be made from a transparent or translucent material, for example silicon or a clear rubber, so that the gaskets do not inhibit the diffusion of light from the LED 9 to the internal surface 12.

The water tight seal prevents the ingress of moisture, water or dust particles into the channel 601 housing the array of LEDs 9. This is particularly advantageous when the cooling device 50 is used in outdoor applications where it is subject to harsh weather conditions or cleaning by a spray, for example in marine applications. Furthermore, the water tight seal provides the added advantage that it prevents condensation potentially forming as cold air 43 from the receptacle 10 contacts the attachment element 2 and the bezel 1.

Similarly, as best viewed in FIG. 3, a barrier gasket 19 may also be located under the hanging shoulder 8 and the radially outer edge 18 of the bezel 1. The barrier gasket 19 provides a waterproof seal between the supporting surface 25 and the bezel 1. Advantageously, this ensures that a waterproof seal is provided around the array of LEDs 9 thus preventing the ingress of water or moisture due to condensation or cleaning. The supporting structure 3 may have an annular groove 20 facing radially outwardly beneath the hanging shoulder 8 to retain the barrier gasket 19 in place.

The bezel 1 is electrically connected to a control module, such as a PCB, via a conductive spring 12. The spring 12 is positioned on a shelf 7 on the supporting structure 3 and electrically connects the bezel 1 to the control module. The cooling device 50 is operated, for example turned ON or OFF, by a user tapping the bezel 1. When a user taps the bezel 1 for a predetermined length of time the control module registers an input.

It is often the case that supporting surfaces 25 have a metallic content. For example, supporting surfaces 25 such as granite contain metallic elements at a microscopic level. Furthermore, many supporting surfaces 25, such as worktops in kitchens, have a metal composite surface finish. In these instances the metallic content of the supporting surface 25 may interfere with the touch sensitive operation of the bezel 1. This is because the control module or PCB is calibrated to work with the specific metal mass of the bezel 1 in order to determine a baseline range and to only register inputs to the control module when it detects electrical charges that go outside the baseline range. This is typical when a user touches the bezel 1. However, when the bezel 1 is installed on a supporting surface 25 with a metallic content then this can cause interference and result in the control module registering false readings.

To mitigate this problem the barrier gasket 19 further serves to electrically insulate the bezel 1 from the supporting surface 25. The hanging shoulder 8 and bezel 1 sit on top of the barrier gasket 19 in normal use thereby electrically insulating the bezel 1 from the supporting surface 25.

The cooling device 50 is clamped to the supporting surface 25 by an annular clamp member 57. The annular clamp member 57 prevents movement of the cooling device 50 relative to the supporting surface 25. The annular clamp member 57 comprises a threaded central aperture configured to cooperate with a threaded external surface 55 of the supporting structure 3. The supporting structure 3 comprises reinforcing tabs 24 that provide support to the hanging shoulder 8. The reinforcing tabs 24 prevent the threaded external surface 55 of the supporting structure 3 extending to the hanging lip 8. This presents a problem when clamping the cooling device 50 to thin supporting surfaces 25.

To mitigate this problem the clamp member 57 comprises a shoulder 52 as shown in FIG. 2. The shoulder 52 protrudes from the clamp member 57 in an upward and outward direction such that the internal diameter of the shoulder 52 may accommodate the reinforcing tabs 24 when the clamp member 57 is secured to the supporting structure 3. This allows the clamp member 57 to engage thin supporting surfaces such that a clamping force may be applied to the supporting surface by the shoulder 52 of the clamp member 57 to secure the cooling device 50 in position.

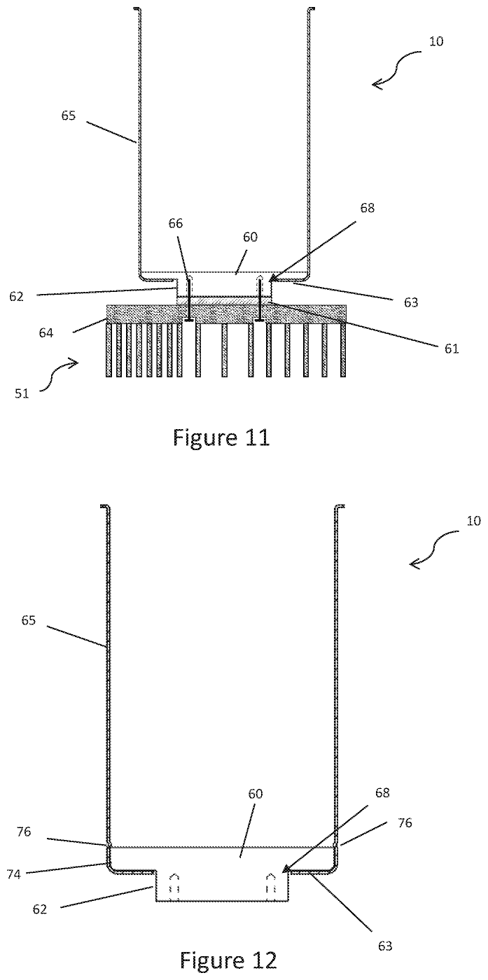

To regulate the temperature of the beverage bottle 42 a cooling module 51 is secured to the base of the receptacle 10. As shown in FIG. 11, the cooling module 51 comprises a thermoelectric cooling device 61, such as a peltier device, and a heat sink 64. The cooling module 51 further comprises a control module having a PCB (not shown).

The thermoelectric cooling device 61 has a cold side that is in contact with the base 60 of the receptacle 10 and a hot side that is in contact with the heat sink 64, in normal use. The cold side of the thermoelectric cooling device 61 extracts thermal energy from the receptacle 10. Thermal energy extracted from the receptacle 10 is dissipated into the atmosphere by the heat sink 64. Cooling the base 60 of the receptacle 10 via the thermoelectric cooling device 61 in turn has the effect of cooling the walls 65 of the receptacle 10 by conduction. Cooling the base 60 and walls 65 of the receptacle 10 creates a sleeve of cool air 43 around the beverage bottle 42 thereby maintaining the temperature of the beverage bottle 42 at the desired drinking temperature.

Whilst the description to this point has been with regards to cooling a beverage bottle 42 the thermoelectric device 61 may equally be controlled to provide heat to the receptacle 10. In this scenario the current provided to the thermoelectric device would be reversed such that the cold side of the thermoelectric device 61 contacts the heat sink 64 and the hot side contacts the base 60 of the receptacle 10. This may be advantageous in scenarios where the ambient temperature is below the desired drinking temperature of the beverage.

For example, a consumer may wish to drink a beverage such as red wine at a temperature between 12° C. and 18° C., sake at temperature of about 40° C. mulled wine at a temperature of about 60° C. The thermoelectric cooling device 61 may be operated to provide heat to the receptacle 10 as required to maintain the beverage bottle 42 at the desired drinking temperature. A temperature sensor may be used to provide feedback to the cooling module 51 regarding the temperature of the air 43 in the receptacle 10 such that the thermoelectric device 61 may be controlled to maintain the temperature within the receptacle 10 at the desired drinking temperature 10.

The cooling device 50 may have selectable operating modes that correspond to the drinking temperature of a bottled beverage 42. For example, the cooling device 50 may have a champagne/white wine mode, a red wine mode, a sake mode and a mulled wine mode. The user of the cooling device 50 may select the desired operating mode by tapping on the bezel 1 or holding the bezel 1 for a length of time. The LEDs 9 may change colour based on the selected operating mode to indicate to the user of the cooling device 50 the selected operating mode. For example, when holding the bezel 1 the user may be able to cycle through the various operating modes and the LEDs 9 would also change colour to represent the operating modes. The user would then let go of the bezel 1 when the LEDs 9 indicate that the desired operating mode is selected.

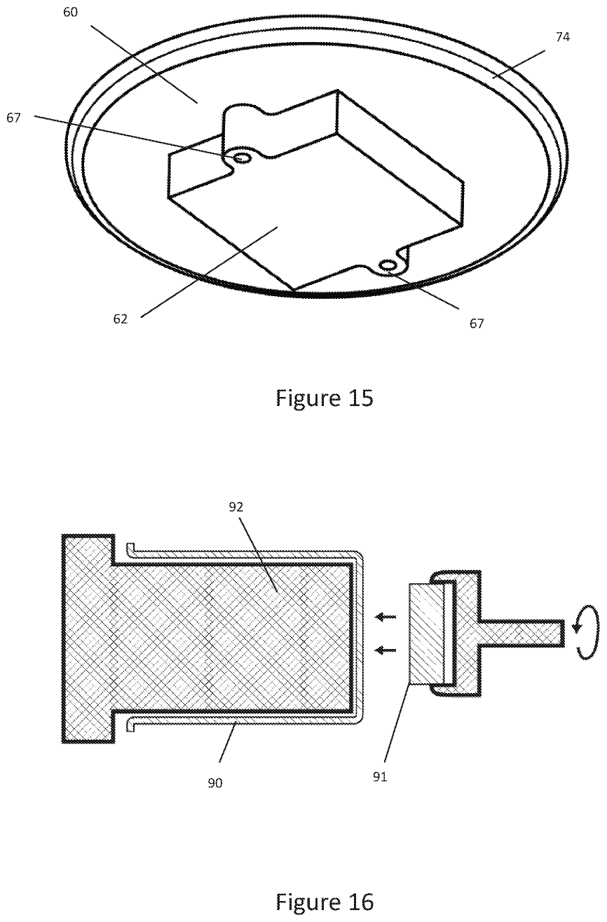

The receptacle 10 comprises a base 60 and tubular wall 65 that are joined to form the receptacle 10, FIG. 15 shows a perspective view of the bottom surface of the base 60. The base 60 is a disc having substantially the same diameter as the walls 65. The base 60 further comprises a step 62 that defines a face that contacts the cold side of the thermoelectric cooling device 61 in normal use, The step 62 is a rectangular raised portion. The step 62 comprises two apertures 67 configured to receive a screw to secure the thermoelectric device to the step 62. The screws may be used to secure the heatsink 64 to the step 62. The step 62 advantageously distances the relatively hot heat sink 64 from the upper surface of the relatively cold base 60 thereby creating a thermal gap. The thermal gap improves the overall efficiency of the cooling module 51

The base 60 of the receptacle 10 provides a strong and rigid structure that can both support the weight of a beverage bottle 42 and can further protect the thermoelectric cooling device 61 from being damaged. Typically, the base 60 is manufactured from a material with a high thermal conductivity such as aluminium, copper or steel.

The receptacle wall 65 may be manufactured from metal spinning, deep drawing, impact extrusion or welding sheet metal to create a cylindrical receptacle 10. The wall 65 of the receptacle 10 has a bottom flange 63 that extends radially inwardly configured to support the base 60 and to create a thermal connection between the base 60 and the walls 65. The bottom flange 63 defines a central aperture 68 for partially receiving the step 62 of the base 60. The wall 65 of the receptacle 10 is thin, for example between 0.5 mm and 3 mm in thickness, meaning that the wall 65 has a low thermal mass such that they can be cooled quickly by the thermoelectric cooling device 61.

The heat sink 64 is secured to the base 60 by screws 66, As the screws 66 are tightened they pull the heat sink 64 towards the base 60 which compresses the thermoelectric cooling device 61 located therebetween. Compressing the thermoelectric cooling device 61 both secures the thermoelectric device 61 in position and also ensures a good thermal connection between the cold face of thermoelectric device 61 and the base 60 and also between the hot face of the thermoelectric device 61 and the heat sink 64. The thermal connection may be further improved by positioning a thermally conductive paste between the cold face and the base 60 and/or between the hot face and the heat sink 64.

In normal use, the cold face of the thermoelectric device 61 contacts the base 60 to provide a cooling effect on the receptacle 10 and thus on the beverage bottle 42. However, prior to powering down the cooling device 50 the control module reverses the polarity of the thermoelectric cooling device 61. This has the effect of switching the hot and cold faces of the thermoelectric cooling device 61 which in turn causes the thermoelectric cooling device 61 to heat the base 60. Heating the base 60 prior to powering down the cooling device 50 causes the entire cooling device 50 to heat up. This is advantageous as it causes residual condensation to evaporate thereby preventing condensation building up and potentially damaging the cooling device 50.

The skilled person will appreciate that the receptacle could be made from a single piece of die-cast material. However, cast materials typically have lower thermal conductivity than wrought or fabricated aluminium due to the impurities introduced in the casting process. Furthermore, manufacturing thin walls in a die-cast can be challenging.

As shown in FIG. 12, the base 60 is supported by flange 63. The flange 63 is sized such that the step 62 on the base 60 is received within the central aperture 68 defined by the flange 63. The base 60 further comprises a fillet edge 74 on the bottom edge of the circular base 60. The fillet edge 74 substantially matches the bend radius between the walls 65 and the bottom flange 63 thereby maximising the contact surface between the base 60 and the walls 65. Maximising the size of the contact surface between the base 60 and the walls 65 is advantageous as it improves the thermal conductivity between the two components.

The base 60 is secured in this position by angularly spaced indents 76 around the wall 65. The indents 76 may be made by a punch or crimp that compresses the wall 65 when the base 60 is in position such that the indents 76 secure the base 60 in position. Alternatively, the indent 76 may be replaced by an annular groove that extends around wall 65 of the receptacle 10. In this embodiment the annular groove is created by spinning the receptacle when the base 60 is in position and indenting the wall 65 to create a groove.

Advantageously, securing the base 60 in position via the use of indents 76 or a groove removes the requirement for additional components such as fixings or fasteners. Furthermore it removes the requirement of welding which in turn results in a clean and aesthetically pleasing finish.

Manufacturing the receptacle 10 from two components also enables the base 60 and the walls 65 to be manufactured from two different materials. For example, the base 60 could be manufactured from copper which has almost double the thermal conductivity of aluminium. Advantageously, therefore, a copper base 60 improves the thermal performance of the cooling module 51.

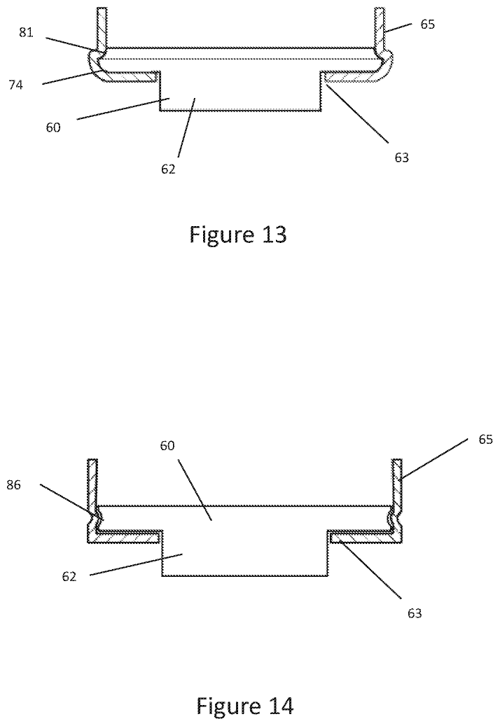

FIG. 13 and FIG. 14 show alternative embodiments of the base 60 and the side wall 65. As shown in FIG. 13, the base 60 has a filleted bottom edge 74 and a filleted top edge 81. The wall 65 has a complimentary shape. In this embodiment the walls of the chamber 65 may be pressed into flush engagement with the filleted top edge 81 of the base 60. This allows a clean and aesthetically pleasing finish between the base 60 and the wall 65 of the chamber. Furthermore, maximising the contact area between the base 60 and the wall 65 of the chamber improves the thermal conductivity of the cooling device 50.

The base 60 shown in FIG. 14 comprises an annular groove 86 that runs around a side face of the base 60. The annular groove 86 enables the side walls of the chamber 65 to be pressed into conformity with the groove to secure the base 60 in position.

The receptacle 10 may also be manufactured by friction welding. FIG. 16 shows a method of manufacturing a receptacle by fusing a block 91 to the base of a cup 90. This may be achieved by spinning a base block 91 at high speed in a concentric axis to the cup 90 or vice versa. The base 91 is then slowly moved toward the base of the cup 90 until they interfere. The resulting friction between the base of the cup 90 and the block 91 creates heat which causes the two parts to melt and fuse together.

A tool 92 is designed to fill the internal space of the cup 90 when the block 91 is fused to the base of the cup 90. The tool 92 advantageously prevents the cup deforming as the block 91 is brought into contact with the base of the cup 90. The tool 92 is manufactured from a material having a higher melting point than the aluminium cup 90.

The receptacle 10 and base 60 may be made from a further method of manufacturing such as through impact extrusion. A mould may be manufactured that is the shape of the receptacle 10 and base 60. A solid block of material, such as aluminium, is positioned within the mould and impacted to deform the aluminium such that it conforms to the shape of the desired receptacle. Extruding the solid block of material in this manner causes the solid block of material to be extruded in both the upward and downward direction thereby creating the thicker base component and the thin vertical walls respectively.

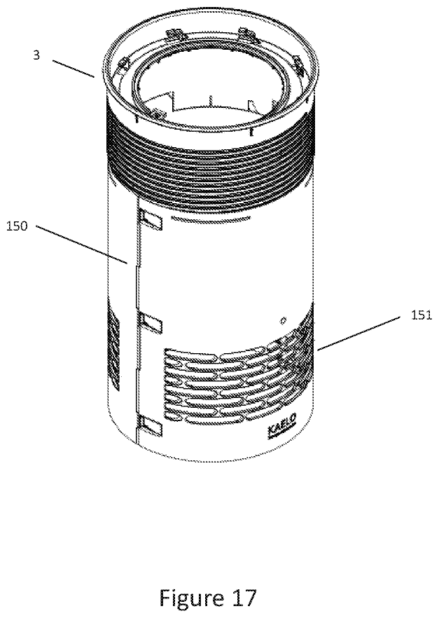

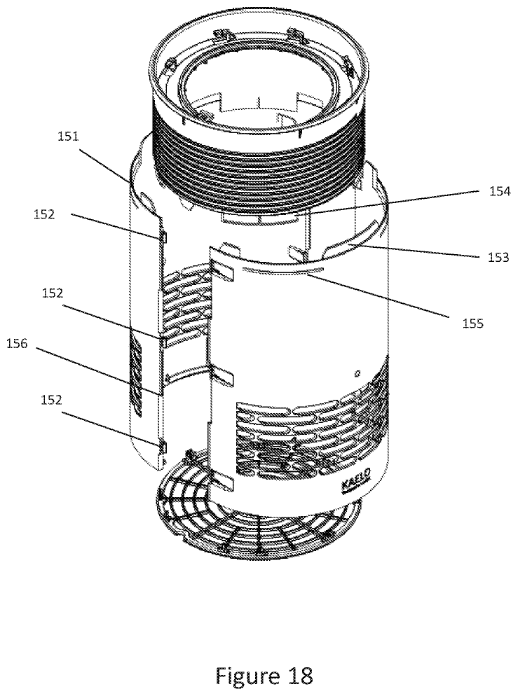

FIGS. 17 and 18 show a chassis 150 secured to the annular supporting arrangement 3. The chassis 150 is designed such that it may be easily secured to the annular supporting structure 3 via interconnecting features positioned on the chassis 150 and the annular supporting structure 3. The chassis 150 is designed to protect the internal features of the cooling device 50 such as the receptacle 10 and the cooling module 51. The chassis 150 comprises a vented area 151 for dissipating heat from the cooling module 51 and particularly the heat sink 64. The vents are elongate which increases the area through which air may flow thereby improving the heat dissipation from the cooling module 51.

As shown in FIG. 18, the chassis 150 is manufactured from two identical semi-circular parts. The split chassis design allows the chassis 150 to be manufactured at a lower cost due to the reduced complexity of tooling.

Interconnecting features located on the chassis 150 and the annular supporting structure 3 allows the chassis 150 to be assembled by hand without the requirement of tools. Furthermore, the two parts of the chassis 150 may be nested within each other when the chassis 150 is in an unassembled state, which advantageously reduces the space the chassis 150 occupies in transit.

The two identical halves of the chassis 150 have complimentary snap-fit locating features 152 positioned on their vertical edges 156 to allow the two halves of the chassis 150 to be fitted together to create a completed chassis 150. The assembled chassis 150 may then be secured to the annular supporting structure 3 using supporting shoulders 153 and snapping feet 154 positioned on the bottom edge of the annular supporting structure 3.

The supporting shoulders 153 on the chassis 150 rest on the internal diameter of the annular supporting structure 3 to maintain concentric alignment between the chassis 150 and the annular supporting structure 3.

The snapping feet 154 lock into slots 155 on the chassis 150. The snapping feet 154 prevent any vertical separation of the annular supporting structure 3 and the chassis 150. Furthermore, the snapping feet 154 also maintain concentric alignment of the chassis 150 and the annular supporting structure 3 and prevent the parts rotating relative to each other. The snapping feet 154 may be positioned such that the two-part chassis 150 can only be connected in a specific orientation.

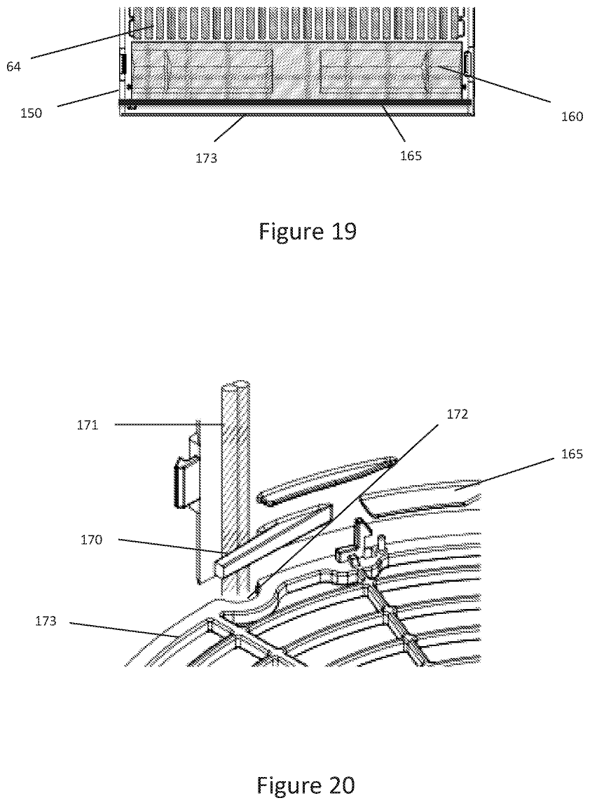

FIG. 19 is a cross-sectional side view of the base 173 of the cooling device 50 when the chassis 150 is secured to the annular supporting structure 3. The cooling fan 160 is supported by a rib or shelf 165 on the internal surface of the chassis 150. The shelf 165 is positioned such that a gap is maintained between the cooling fan 160 and the base 173 of the chassis 150. This is advantageous as the gap improves air flow across the cooling fan 160 thereby improving heat dissipation from the cooling module 51. Furthermore the gap protects the cooling fan 160 from being damaged if the base 173 of the cooling device 50 is slightly dented.

Finally, FIG. 20 shows a clamp 170 configured to clamp a power cable 171 to the internal wall of the chassis 150. In the example shown, the clamp 170 is integral with the wall of the chassis 150 such that the cable 171 may be easily secured in position by the clamp 170. The clamp 170 compresses the power cable 171 against the wall of the chassis 150 such that it does not interfere with the operation of the cooling fan 160. The clamp 170 also ensures that if the power cable 171 is pulled it does not damage the PCB of the control module.

The cable 171 is located in a peripheral notch 172 in the base 173 of the chassis 150. The slot 172 is positioned on the periphery of the base, Beneficially, the slot 172 has an open side meaning that any size of connector may be used with the base 173 of the chassis 150. This is because the connector on the cable 171 may be connected to the PCB prior to the base 173 being fitted to the chassis 150. When the base 173 is fitted to the chassis 150 the cable 171 may be easily clamped by clamp 170 and located in the slot 170.

1. A bottle cooler, comprising:
an annular support structure that has a hanging shoulder protruding radially outwardly;
a hollow open-topped receptacle that is suspended from the support structure; and
a bezel that surrounds the open top of the receptacle and covers the hanging shoulder.

2. The bottle cooler according to claim 1, wherein the bezel is connected to the support structure by an intermediate attachment element.

3. The bottle cooler according to claim 2, wherein the attachment element comprises a clip for securing the bezel to the attachment element.

4. The bottle cooler according to claim 3, wherein the bezel comprises a rim and wherein the rim engages the clip to secure the bezel to the attachment element.

5. The bottle cooler according to claim 2, wherein the attachment element comprises locating pins configured to engage a corresponding engagement slot on the bezel to prevent relative movement between the attachment element and the bezel.

6. The bottle cooler according to claim 2, wherein a radially extending tab connects the bezel to the support structure.

7. The bottle cooler according to claim 6, wherein the attachment element comprises the tab.

8. The bottle cooler according to claim 7, wherein the tab is rotatably engageable with the support structure.

9. The bottle cooler according to claim 8, wherein the support structure comprises at least one support clip for engaging the tab.

10. The bottle cooler according to claim 2, wherein the bezel is removable from the support structure.

11. The bottle cooler according to claim 9, further comprising an annular gasket that covers a portion of the open top of the receptacle such that when a bottle is located in the receptacle the gasket forms a seal between the bottle and the receptacle.

12. The bottle cooler according to claim 11, wherein the at least one support clip comprises an upper engagement lip and a lower engagement lip and wherein the support clip is configured such that the tab engages the upper engagement lip when the gasket is present and such that the tab engages the lower engagement lip when the gasket is not present.

13. The bottle cooler according to claim 1, wherein a light source is mounted on the support structure.

14. The bottle cooler according to claim 13, wherein the support structure comprises a lip positioned between the light source and the receptacle configured to provide a thermal barrier between the light source and the receptacle.

15. A bottle cooler, comprising:
a hollow open-topped receptacle;
a bezel that surrounds the open top of the receptacle; and
a light source,
wherein the bezel is attached to the bottle cooler by an attachment element that is configured to convey light emitted by the light source to the open top of the receptacle.

16. The bottle cooler according to claim 15, wherein the attachment element is a diffuser lens.

17. The bottle cooler according to claim 16, wherein the attachment element comprises a groove aligned with the light source and wherein the groove is configured to refract the light towards the open top of the receptacle.

18. The bottle cooler according to claim 17, wherein the groove comprises a light receiving surface and wherein the light receiving surface has a rough surface finish configured to diffuse incident light emitted from the light source.

19. The bottle cooler according to claim 15, wherein the attachment element comprises a central aperture that extends around the open top of the receptacle.

20. The bottle cooler according to claim 15, wherein the receptacle comprises:
a tubular wall component comprising an inwardly protruding support flange; and
a base component,
wherein the base component engages the support flange to define a base of the receptacle.

21. A bottle cooler according to claim 20, wherein the base component comprises a step portion and wherein the support flange defines an aperture for locating the step portion.

22. The bottle cooler according to claim 21, wherein the base component is secured to the wall component by an indent feature on the wall component.

23. The bottle cooler according to claim 22, wherein the base component comprises a filleted edge and wherein the filleted edge is configured to engage the indent feature.

24. The bottle cooler according to claim 22, wherein the base component comprises an annular groove and wherein the indent feature is configured to engage the annular groove.

25. The bottle cooler according to claim 24, wherein the indent feature defines an internal annular ridge on the tubular wail component.

26. The bottle cooler according to claim 25, wherein the wall component comprises an outwardly protruding flange at an end opposed to the base component.
